(19) United States
(12) Patent Application Publication
(10) Pub. No.: US 2026/0093903 A1
(43) Pub. Date: Apr. 2, 2026

(54) SYSTEMS AND METHODS FOR AI-BASED DOCUMENT MANAGEMENT AND AUTOMATED ELECTRONIC SUBMISSION TEMPLATE AND RESOURCE FORM COMPLETION

(71) Applicant: REGDESK, Houston, TX (US)

(72) Inventors: Jixian WANG, Houston, TX (US); Jerry Tang, Houston, TX (US); Priyanka Paul Bhutani, Houston, TX (US)

(21) Appl. No.: 18/903,719

(22) Filed: Oct. 1, 2024

(51) Int. Cl. G06F 40/174; G06F 16/33; G06F 16/383; G06F 40/177

(52) U.S. Cl. CPC G06F 40/174; G06F 16/3347; G06F 16/383; G06F 40/177

(57) ABSTRACT

Systems, methods, and devices for managing and processing electronic documents by extracting semantic information, generating high-dimensional embeddings, and automating form completion through advanced natural language processing (NLP) models and optimized similarity algorithms may include receive a plurality of electronic files associated with an electronic Submission Template and Resource (eSTAR) form. Semantic information may be extracted from the plurality of electronic files using a pre-trained natural language processing (NLP) model. The electronic files may be segmented into content slices based on the extracted semantic information. The content slices and the corresponding high-dimensional embeddings may be stored in a vector database. An indication of one or more sections of the eSTAR form may be received. The indication of the one or more sections of the eSTAR form may be converted into one or more query embeddings. A set of content slices of the plurality of content slices may be determined and transmitted.

### TECHNICAL FIELD

The present disclosure generally relates to systems and methods for document management, and more particularly to artificial intelligence (AI) based document management and automated completion of electronic Submission Template and Resource (eSTAR) forms.

### BACKGROUND

Businesses and organizations need document management systems to store, manage, and retrieve documents in order to maintain operational efficiency or regulatory compliance. For example, a law firm may handle thousands of case files, contracts, and legal documents that need to be securely stored and accessible to authorized personnel. Similarly, a healthcare organization may manage patient records, insurance forms, or medical histories. In the financial sector, banks and investment firms may store transaction records, compliance documents, or client information.

In conventional document management systems, files are typically organized using folder-based, tag-based, or database-based methods. Folder-based management systems require users to categorize files into distinct directories, which can be inefficient when a single file belongs to multiple categories. For example, a document relevant to multiple projects must be duplicated and stored in several folders, leading to redundancy and increased storage requirements. Folder-based management also makes updating documents cumbersome, as each copy must be individually updated to maintain consistency.

Tag-based management systems may offer improved categorization by allowing users to assign multiple tags to files. However, assigning tags to files increases data entry costs and can be cumbersome when dealing with large batches of files. Tagging each document manually is a time-consuming process and may not always be accurate or consistent, leading to difficulties in retrieval and classification.

Conventional database-based management systems rely on metadata to index and search for files, where the metadata usually includes descriptive information about the files, such as titles, authors, and keywords. While a database-based approach may facilitate faster searches, it introduces new problems. For example, with a large number of files, fuzzy matching based on metadata often results in significant performance overhead. Moreover, if searches are based solely on metadata, the database must match each entry, which can lead to information omissions. For global searches, the system must open each file for string matching, which is unacceptable when handling large volumes of files. Additionally, the accuracy of searches heavily depends on the quality and completeness of the metadata, which can be inconsistent.

These conventional methods often fail to address the challenges of handling complex data structures and ensuring efficient retrieval of relevant information. Moreover, the process of manually locating and extracting the necessary content from a multitude of documents is time-consuming and error prone. This is particularly problematic in scenarios where precise and rapid information retrieval is critical, such as in legal, medical, or regulatory environments.

Accordingly, there is a need for a more advanced document management system that can automatically and accurately manage, classify, and retrieve content from electronic files.

This background information is provided to reveal information believed by the applicant to be of possible relevance. No admission is necessarily intended, nor should be construed, that any of the preceding information constitutes prior art.

### SUMMARY

Briefly described, and in various embodiments, the present disclosure generally relates to document management and automation systems, specifically within the context of electronic Submission Template and Resource (eSTAR) form completion.

Moreover, the present disclosure is particularly relevant to systems and methods for managing and processing electronic documents by extracting semantic information, generating high-dimensional embeddings, and automating form completion through advanced natural language processing (NLP) models and optimized similarity algorithms.

According to some aspects, a plurality of electronic files associated with an eSTAR form may be received. The electronic files may include various document formats, including DOC, PDF, HTML, and scanned images. The electronic files may be managed in a distributed database setup. Moreover, other document management systems may be integrated to import and export the electronic files.

Using a pre-trained natural language processing (NLP) model, semantic information may be extracted from the files and high-dimensional embeddings may be generated based on the semantic content. For example, optical character recognition (OCR) may be used to extract text from scanned image files before generating the high-dimensional embeddings. The electronic files may be segmented into content slices. According to some aspects, metadata tags may be assigned to content slices based on extracted semantic information. Each content slice may be associated (e.g., using both general and domain-specific language models) with a corresponding high-dimensional embedding. The content slices may be stored in a vector database. The content slices may be encrypted before storing them in the vector database to enhance data security.

Indications of sections of the eSTAR form may be received. The indications may be converted into query embeddings using the NLP model. The NLP model may be trained using domain-specific data related to the type of submissions associated with the eSTAR form. By searching the vector database with an optimized similarity algorithm (e.g., including one or more machine learning algorithms), the system determines relevant content slices may be determined and the relevant content slices may be transmitted for form completion. For example, a confidence score may be determined for each identified content slice, indicating its relevance to the query embeddings. Moreover, query embeddings may be refined based on user feedback to improve future searches.

Furthermore, the identified content slices may be inserted into the eSTAR form, and the completed form may be transmitted. A user interface allows users to manually refine or correct the extracted content slices before they are inserted into the eSTAR form. Moreover, approval of the content slices may be received from a user and the vector database may be updated based on the approval (e.g., enhancing the accuracy and relevance of the stored data). Moreover, the pre-trained NLP model may be periodically updated to improve performance and maintain accuracy.

According to some aspects, the content slices may include references to their original locations within the electronic files for traceability, and an audit trail of all modifications made to the content slices and/or updates to the vector database may be provided to a user. The vector database may support version control for each content slice, allowing users to revert to previous versions if needed. Moreover, the eSTAR form may be collaborative edited by multiple users simultaneously. Additionally, a recommendation engine may suggest relevant content slices based on a user's previous queries and selections. Natural language summaries of the content slices may be provided to assist users in quickly understanding the extracted information.

According to some aspects, the disclosed systems and computing devices may operate in offline mode, processing and storing data locally.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an example of an environment for a document management system;

FIG. 2 illustrates an exemplary data process flow;

FIG. 3 illustrates an exemplary entity relationship diagram;

FIG. 4 illustrates an exemplary data query sequence;

FIG. 5 illustrates an exemplary data input sequence;

FIG. 6 illustrates an exemplary process;

FIG. 7 illustrates a schematic of an exemplary device; and

FIG. 8 illustrates an exemplary diagrammatic representation of a machine in the form of a computer system.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

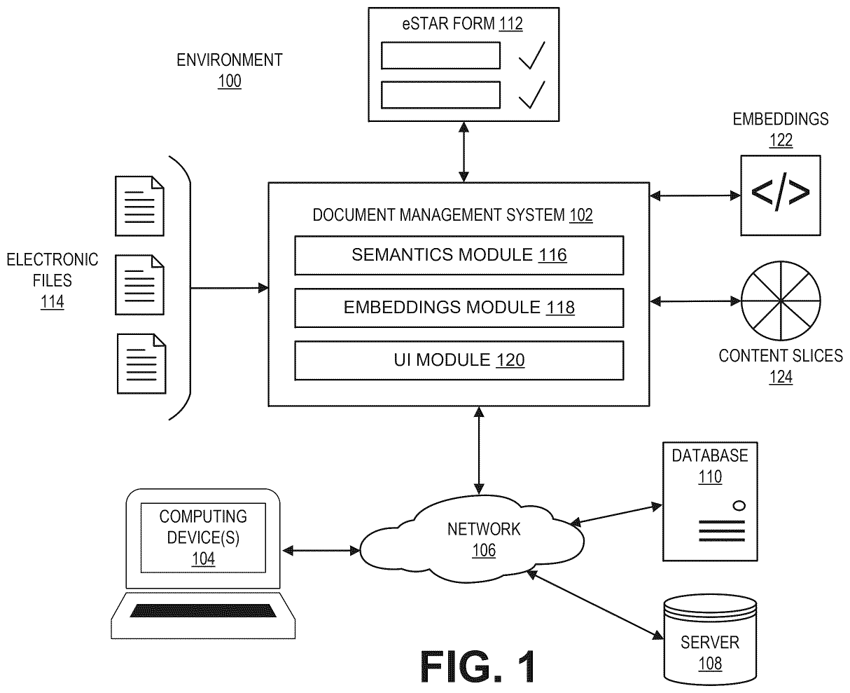

Referring now to the figures, for the purposes of example and explanation of the processes and components of the disclosed systems and methods, reference is made to FIG. 1, which illustrates an example environment 100 for a document management system 102 designed to facilitate the efficient handling and processing of electronic documents, particularly for the completion of electronic Submission Template and Resource (eSTAR) forms. The environment 100 includes various components such as one or more computing devices 104, a network 106, a server 108, and a vector database 110, each of which may interact to support the functionality of the document management system 102.

The document management system 102 may receive a plurality of electronic files 114 associated with an eSTAR form 112. The electronic files 114 may be in various formats, including DOC, PDF, HTML, and/or scanned images. Moreover, the document management system 102 may provide scalability and reliability by managing files stored across different locations, including one or more distributed databases. The eSTAR form 112 may include a standardized template (e.g., for various regulatory and administrative applications) that collects, organizes, and processes a wide range of data from multiple electronic documents. The eSTAR form 112 may be associate with one or more industries requiring documentation and regulatory compliance, such as healthcare, legal, or finance. The eSTAR form 112 may include one or more structured data fields or intelligent prompts to accurately capture and organize all necessary information, reducing errors and omissions that can occur with traditional forms. Additionally, the eSTAR form 112 may support collaborative editing, allowing multiple users to work on the eSTAR form 112 simultaneously, and may include features for user approval and version control, thereby enhancing the overall efficiency and reliability of the submission process.

The document management system 102 may increase functionality of the eSTAR form 112 by automating one or more aspects of form completion. The document management system 102 may extract relevant data from various document formats associated with the electronic files 114 (e.g., DOC, PDF, HTML, or scanned images) and segment the data into content slices 124 associated with embeddings 122. These embeddings 122 may be matched with the corresponding sections of the eSTAR form 112, e.g., using an optimized similarity algorithm. Thereby the document management system 102 may expedite form completion and automatically complete the eSTAR form with information that is contextually accurate and relevant.

The document management system 102 may include several modules, each of which may perform distinct functions. The Semantics Module 116 may extract semantic information from the electronic files 114 using a pre-trained natural language processing (NLP) model. The Semantics Module 116 may ingest the contents of various document formats associated with the electronic files 114 (e.g., DOC, PDF, HTML, or scanned images). For scanned images, the Semantics Module 116 may employ optical character recognition (OCR) to convert the image-based text into machine-readable text.

Once the text is accessible, the pre-trained NLP model may process the text to understand the context and meaning of the content. The processing may include tokenizing the text into smaller units, such as words and sentences, and then applying syntactic and semantic analysis to identify relationships between these units. The NLP model, which may be trained on vast amounts of text data, may generate a detailed representation of the text's semantic structure. For example, if the electronic file 114 contains a research article, the Semantics Module 116 may identify key components such as the title, abstract, introduction, methods, results, and conclusions. The Semantics Module 116 may achieve this by recognizing specific patterns and terminologies commonly found in research articles. The Semantics Module 116 may include general and domain-specific language models to provide a nuanced understanding of the text, distinguishing between similar terms used in different contexts. For instance, the term “cell” in a biological context refers to a biological unit, whereas in a telecommunications context, it refers to a network area. The NLP model's training on diverse datasets may enable it to make these distinctions accurately, ensuring that the extracted semantic information is both relevant and precise.

The Semantics Module 116 may then generate high-dimensional embeddings for each segment of the text, capturing the semantic essence of the content. These embeddings are vectors that represent the meaning of the text in a numerical format, making it easier to compare and search through large volumes of data.

The Embeddings Module 118 may generate embeddings 122 by converting the semantic information extracted by the Semantics Module 116 into numerical representations that capture the contextual meaning of the text. For example, the Semantics Module 116 may use advanced techniques such as word embeddings and sentence embeddings, which may be created through neural network models such as Word2Vec, GloVe, or BERT. The models may be pre-trained on large corpora of text data and may understand complex linguistic patterns and relationships. The Embeddings Module 118 may process each text segment, encoding the semantic information into high-dimensional vectors. Each vector may be a point in a multi-dimensional space, where semantically similar texts are positioned closer together, facilitating efficient comparison and retrieval.

For example, consider a segment from a legal document that discusses “intellectual property rights.” The Embeddings Module 118 may generate a high-dimensional vector for this text, capturing its semantic nuances. This vector may have multiple dimensions, each representing different aspects of the text's meaning. Dimensions may encode various features such as syntactic structure, contextual relevance, and domain-specific terminology. If another document segment discusses “patent laws,” the generated vector may be close to the “intellectual property rights” vector in the high-dimensional space, reflecting their semantic similarity. This numerical format may allow the document management system to perform rapid searches and comparisons across large datasets. For instance, when a user queries the document management system 102 for information related to intellectual property, the Embeddings Module 118 may quickly compare a query vector with stored vectors, ensuring accurate and contextually appropriate results.

The document management system 102 may segment the electronic files 114 into a plurality of content slices 124 based on the extracted semantic information using a sophisticated text analysis process. The document management system 102 may perform a sliding window method, where the text may be divided into overlapping segments to ensure that the context is preserved across segment boundaries. For example, a window size of 200 words with a 50-word overlap may prevent important sentences or phrases that span across segments from being fragmented. Utilization of the sliding window may maintain the semantic integrity of the content slices 124, allowing each segment to be understood within its broader context.

Once the text is divided into initial segments, the document management system 102 may apply the pre-trained NLP model to analyze the semantic content of each segment. The document management system 102 may evaluate the semantic similarity between adjacent segments to decide if they should be merged or kept separate. For instance, if two adjacent segments discuss closely related topics, the document management system 102 may merge them into a single content slice 124 to avoid losing semantic coherence. Each finalized content slice 124 may then associated with an embedding 122 generated by the Embeddings Module 118. For example, in a research paper, the document management system 102 may segment the text into content slices 124 representing the introduction, methodology, results, and conclusion, each associated with an embedding 122 that encapsulates its specific content. This segmentation process may ensure that the document's meaning is preserved and accessible for computational analysis, facilitating accurate and context-aware searches within the document management system 102.

Moreover, the document management system 102 may include version control mechanism for each content slice 124 stored in the vector database 110. The version control may enable users to track changes made to the content slices 124 over time, including modifications, approvals, or deletions. Each version of a content slice 124 may be stored as a separate entry in the vector database 110, preserving the historical context of the data. This functionality may be important in regulatory environments where maintaining a detailed audit trail is essential for compliance purposes. Users interacting with the system via the UI Module 120 may view the version history of any content slice 124, compare different versions, and, if necessary, revert to a previous version. The version control may help users and/or the document management system 102 to determine that the most accurate and relevant data is used during the completion of the eSTAR form 112.

The document management system 102 may store the content slices 124 and their corresponding embeddings 122 in a vector database 110 to facilitate efficient retrieval and management of document data. Once the content slices 124 are generated and associated with their respective embeddings 122, the document management system 102 may prepare the content slices 124 and their respective embeddings 122 for storage by organizing the data into a structured format suitable for the vector database 110. Each content slice 124, along with its embedding 122, may be indexed and labeled with metadata tags that include references to the original electronic file, the segment's position within the electronic file 114, and other relevant attributes.

The vector database 110 may enable rapid and accurate searches by handling large volumes of high-dimensional data. The vector database 110 may utilize advanced indexing techniques such as k-d trees or R-trees to organize the high-dimensional vectors efficiently. When storing the content slices 124 and embeddings 122, the document management system 102 may maintain the spatial relationships of the vectors, allowing for optimized similarity searches. For instance, when a query is processed, the vector database 110 may quickly locate and retrieve the most relevant content slices 124 based on the proximity of their embeddings 122 to the query embedding. This organization may allow the document management system 102 to perform complex queries and comparisons across extensive datasets, providing users with precise and contextually relevant results. Additionally, the vector database 110 may support encryption of the content slices 124 before storage, enhancing data security and ensuring that sensitive information is protected. This secure and efficient storage mechanism may maintain the integrity and accessibility of the vast and semantically rich dataset of the document management system 102.

The document management system 102 may receive indications of one or more sections of the eSTAR form 112, e.g., through interactions facilitated by the UI Module 120. The UI Module 120 may provide a user-friendly interface on the computing device 104, allowing users to interact with the document management system 102 intuitively. For example, the interface may display the eSTAR form 112 in a structured manner, breaking it down into various sections such as personal information, project details, compliance data, etc. Users may navigate through these sections using interactive elements such as clickable buttons, dropdown menus, and text input fields. By selecting or highlighting specific sections of the eSTAR form 112, users may indicate which parts they are focusing on or need assistance with.

Once the user indicates a section through the UI, the UI Module 120 may capture the input and may format the input for further processing by the document management system 102. For example, if a user selects the “Project Details” section, the UI Module 120 may generate a corresponding query or command that specifies the “Project Details” section. The Embeddings Module 118 may convert the user's indication into one or more query embeddings using the pre-trained NLP model, effectively capturing the semantic intent of the input. The embeddings 122 may be used to search the vector database 110 for relevant content slices 124 that match the specified section of the eSTAR form 112. This interaction between the user, the UI Module 120, and the backend components of the document management system 102 may provide a seamless and efficient workflow, enabling accurate and contextually appropriate data retrieval for form completion.

The document management system 102 may convert the indication of the one or more sections of the eSTAR form 112 into one or more embeddings 122 using the pre-trained natural language processing (NLP) model. When a user or a computing device 104 indicates a specific section of the eSTAR form 112, the input may be processed by the Embeddings Module 118. For example, the Embeddings Module 118 may leverage the pre-trained NLP model to understand the semantic context and intent behind the user's indication. For example, if the user selects the “Project Details” section, the document management system 102 may interpret the input to mean that information related to project specifics, such as objectives, scope, and timelines, is required.

The Embeddings Module 118 may generate embeddings 122 that capture the semantic essence of the indicated section. Generating the embeddings 122 may include encoding the textual description of the form section into numerical vectors using the NLP model. The vectors and/or embeddings 122 may represent the meaning and context of the user's input in a format that can be used for computational analysis. The embeddings 122 may be comparable in a high-dimensional space, where similar meanings result in vectors that are close to each other. For instance, if the section indicated is related to “financial details,” the embeddings 122 may reflect financial terminology and context. The embeddings 122 associated with the query may be used to search the vector database 110 for content slices 124 that match the intended information, facilitating retrieval of the most relevant and contextually accurate data to populate the eSTAR form 112. This conversion process may allow the document management system 102 to efficiently and accurately understand and respond to user queries, leveraging the power of advanced NLP techniques.

The document management system 102 may determine one or more content slices 124 by searching the vector database 110 for the embeddings 122 generated based on the user's indication of the sections of the eSTAR form 112. When the Embeddings Module 118 converts the user's input into embeddings 122, the embeddings 122 may encapsulate the semantic intent and context of the required information. The vector database 110, which may store content slices 124 along with their corresponding embeddings 122, may be searched using these embeddings 122. The search process may include comparing the embeddings 122 to the embeddings stored in the vector database 110 to identify content slices 124 that are semantically similar.

A search algorithm employed by the document management system 102 may use optimized similarity algorithms, such as approximate nearest neighbor (ANN) techniques, to efficiently locate the most relevant content slices 124. The similarity between embeddings 122 may be measured by calculating the distance between the query embeddings and the stored embeddings in the high-dimensional space. Content slices 124 with embeddings that are closest to the query embeddings may be deemed the most relevant. For instance, if the query embedding represents a request for “project timelines,” the document management system 102 may retrieve content slices containing information about project schedules and deadlines. Additionally, the document management system 102 may generate a confidence score for each identified content slice, indicating the relevance of the content slice to the query embeddings. Therefore, the most contextually appropriate and accurate data may be selected to populate the eSTAR form 112, enhancing the overall efficiency and reliability of the document management process.

The document management system 102 may transmit the identified content slices 124 to the one or more computing devices 104 or directly to a user operating the computing devices 104. For example, the document management system 102 may provide the identified content slices 124 as filled-in sections of the eSTAR form 112. Once the document management system 102 determines the most relevant content slices 124 based on the embeddings 122, the document management system 102 may compile the content slices 124 into a structured format suitable for form completion. The filled-in sections may be generated by inserting the content slices 124 into the appropriate fields of the eSTAR form 112, ensuring that each section of the eSTAR form 112 is accurately populated with the corresponding data extracted from the electronic files 114.

The transmission process may be facilitated by the UI Module 120, which may manage the interaction between the document management system 102 and the user interface on the computing devices 104. The UI Module 120 may display the filled-in sections of the eSTAR form 112 in an organized and user-friendly manner. Moreover, the interface provided by the UI Module 120 may allow users to manually refine or correct the extracted content slices before they are inserted into the eSTAR form 112. The document management system 102 may also receive approval of the content slices and update the vector database 110 based on this approval, ensuring the accuracy and relevance of the stored data. For example, the eSTAR form may be presented on the user's screen with highlighted fields indicating the newly inserted content slices 124. Users may review the filled-in sections, make any necessary adjustments, or provide approval for the completed form. The document management system 102 can also handle various data formats, providing compatibility with the user's device and software. This seamless transmission and integration process may automate the form completion task, reducing manual effort, and providing information that is both accurate and contextually relevant.

According to some aspects, the document management system 102 may integrate with other document management systems to facilitate the import and export of electronic files 114. This integration may facilitate data exchange between different platforms, ensuring that electronic files 114 associated with the eSTAR form 112 can be easily transferred between systems without requiring manual intervention. For example, the electronic files 114 may be stored in a cloud-based system. The document management system 102 may utilize API-based communication to retrieve the electronic files 114 for processing by the Semantics Module 116 and/or the Embeddings Module 118. This interoperability may enhance the flexibility of the document management system 102 and allow it to function within diverse IT ecosystems.

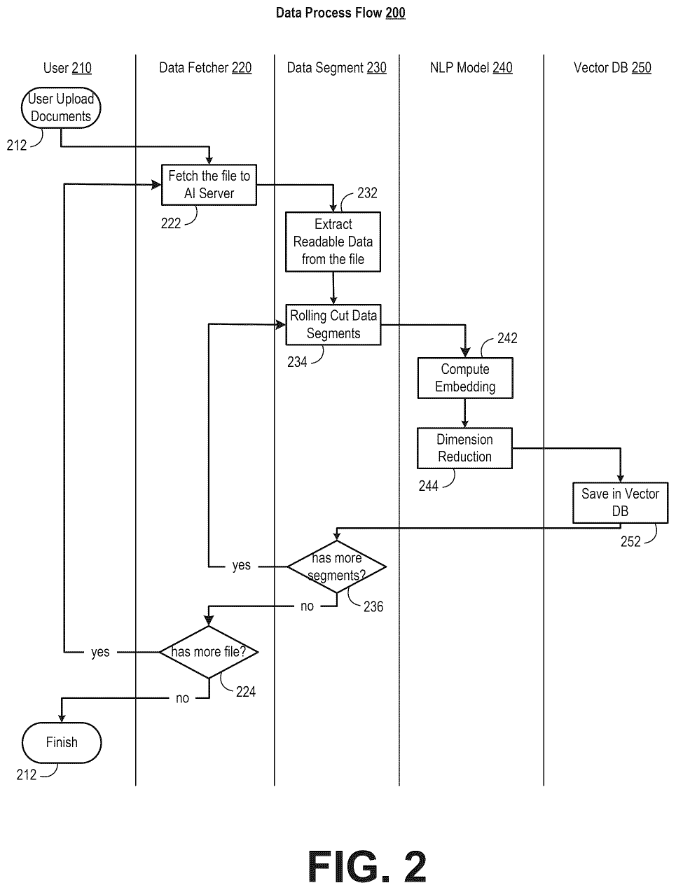

As illustrated in FIG. 2, the data process flow 200 sets forth a sequence of steps that the document management system 102 may implement to manage, process, and/or retrieve electronic documents. At step 212, a user process 210 may upload electronic documents. At step 222, a data fetcher process 220 may fetch the file to an AI server. At step 232, a data segment process 230 may extract readable data from the file. At step 242, the data segment process 230 may determine rolling cut data segments. At step 242, the NLP model may compute embeddings. At step 244, the NLP model 240 may perform dimension reduction. At step 252, the vector database 250 may save the output from step 244 in the vector database. At step 236, the data segment process 230 may determine if there are more segments. If there are more segments, the data process flow 200 may return the additional segments to step 234 of the data process flow 200. If there are not more segments, the data fetcher process 220 may determine at step 224 if there are additional files. If there are additional files, the data process flow 200 may return to step 222 of the data process flow 200. If there are not additional files, the user process 210 may finish at step 212.

The data process flow 200 illustrated in FIG. 2 provides a systematic sequence of operations implemented by the document management system 102 for managing, processing, and retrieving electronic documents. The process begins with the user process 210 at step 212, where a user uploads electronic documents. These documents may include a variety of formats such as DOC, PDF, HTML, and scanned images, which are then processed by the system. The documents may originate from different sources, such as regulatory filings, legal contracts, medical records, or financial documents, depending on the industry and specific use case.

Uploading the electronic documents typically begins with a user interacting with the system via a user interface provided by the UI Module 120. The user may access the user interface on a computing device 104, such as a desktop computer, tablet, or smartphone, connected to the network 106. The UI Module 120 may offer an intuitive platform for users to select and upload the documents, either by dragging and dropping files into the interface, browsing the file system, or connecting to external sources, such as cloud storage platforms or integrated document management systems.

Once selected, the electronic documents may be uploaded to the document management system 102 through a secure transfer protocol, ensuring that the files are transmitted without data loss or corruption. The document management system 102 may support batch uploads, allowing users to upload multiple files simultaneously. During the upload, metadata associated with the files, such as the document title, author, and date of creation, may also be captured to aid in subsequent indexing and retrieval processes.

At step 222, the data fetcher process 220 may retrieve the uploaded file and forward it to an AI server for further processing, operating as an intermediary to efficiently and securely transfer\ the uploaded files from the storage location to the AI server. The data fetcher process 220 may be initiated by the uploading of the documents and may include accessing the storage location where the documents are temporarily held. The storage location may be on a local server, a distributed database, or cloud storage, depending on the system architecture and where the files were initially uploaded at step 212. The data fetcher process 220 may forward the electronic documents to the AI server over a secure network connection. The transfer may involve encryption protocols to protect sensitive information during transit, ensuring compliance with data security standards. The data fetcher process 220 may also include error-checking mechanisms to verify that the documents have been successfully transferred and are ready for processing, thereby maintaining the integrity of the data process flow 200.

The AI server, which may operate within a distributed system, may then initiate the data segment process 230 at step 232. The AI server may use advanced AI models to extract readable data from the uploaded files, transforming the raw content into structured segments that can be further processed. The data segment process 230 may include the AI server using Optical Character Recognition (OCR) models if the electronic documents contain scanned images or non-text formats. The OCR models may convert the image-based text into machine-readable text, ensuring that the content is accessible for subsequent processing. Once the text is extracted, the AI server may utilize Natural Language Processing (NLP) models to analyze the text's structure and semantics. The NLP models may include pre-trained models such as BERT (Bidirectional Encoder Representations from Transformers) or GPT (Generative Pre-trained Transformer), one or more of which may be used to understand context, extract relevant information, and/or identify key components of the text.

The AI server may segment the extracted data into meaningful units or “content slices” based on the semantic information derived by the NLP models. The segmentation may involve breaking down the text into paragraphs, sentences, or other logical units, depending on the document's content and structure. The AI models may be trained to recognize patterns and contextual cues within the text, ensuring that each segment maintains its semantic integrity. For example, in a legal document, the AI models may segment the text into sections such as “Introduction,” “Facts,” “Analysis,” and “Conclusion,” ensuring that each segment reflects a coherent piece of the document's overall structure.

Once the readable data is extracted, the data segment process 230 may determine rolling cut data segments (e.g., “content slices”) at step 242. Determining rolling cut data segments may comprise dividing the text into overlapping content slices to preserve contextual integrity. A sliding window method may be used to keep important semantic content from being lost between segments. The data segments may be used to maintain the coherence of the extracted information. For example, if a text segment includes a complex sentence or a multi-sentence idea, cutting the text at a fixed point could result in fragmented content that loses its meaning or context. By using a sliding window approach, where the window size may, for example, be set to capture 200 words with a 50-word overlap, each content slice may contain sufficient contextual information from the preceding and succeeding portions of the text. The document management system 102 may maintain the coherence of the extracted information, making each segment more semantically complete and meaningful when processed further, such as during the generation of high-dimensional embeddings or when matching content slices to specific sections of an eSTAR form. The overlapping segments may also allow the document management system 102 to perform more accurate and contextually aware searches, as it minimizes the risk of critical information being isolated or misinterpreted due to segmentation.

Following segmentation, the data process flow 200 may advance to step 242, where the Natural Language Processing (NLP) model 240 may compute embeddings for each content slice. The embeddings may be high-dimensional vectors designed to encapsulate the semantic essence of the content. The process of computing embeddings may include the NLP model analyzing the text within each content slice to understand its contextual meaning, syntactic structure, and/or the relationships between words and phrases. The NLP model 240, which may be pre-trained on extensive datasets, may apply transform the textual information into numerical representations that exist within a multi-dimensional space.

Each embedding may serve as a unique fingerprint of the content slice, with dimensions that encode various aspects of the text, such as the importance of certain terms, the presence of domain-specific language, and the overall context in which the information is presented. For instance, a content slice discussing “data privacy regulations” may include an embedding that positions it close to other slices related to legal compliance or cybersecurity in the high-dimensional space. This proximity in the vector space may allow for efficient similarity comparisons, making it easier for the document management system 102 to retrieve relevant content when a query is made. The embeddings may enable the document management system 102 to bypass traditional keyword-based searches, instead leveraging the deep, context-aware understanding of the text to deliver highly accurate and relevant results. Moreover, the document management system 102 may enhance search and retrieval efficiency, handling large volumes of data while maintaining a high level of precision in matching content to queries or specific sections of the eSTAR form.

At step 244, the NLP model 240 may undertake the process of dimension reduction on the high-dimensional embeddings to optimize both storage and retrieval efficiency within the vector database. Each embedding, originally represented as a vector in a multi-dimensional space, may contain hundreds or even thousands of dimensions, encapsulating intricate details about the semantic content of the text. While these detailed embeddings may facilitate capturing the nuanced meaning of the text, the detailed embeddings may also lead to significant storage requirements and computational overhead during retrieval processes.

To address these challenges, the NLP model 240 may apply one or more advanced dimension reduction techniques such as Principal Component Analysis (PCA), t-Distributed Stochastic Neighbor Embedding (t-SNE), or autoencoders. The number of dimensions in the embeddings may be reduced while preserving as much of the original semantic information as possible. By identifying and retaining the most critical features that contribute to the overall meaning of the text, dimension reduction may compress the embeddings into a lower-dimensional space that is more manageable and efficient for storage.

This reduction in dimensionality may decrease the storage footprint of each embedding within the vector database and/or accelerate the retrieval process. When a search query is made, the reduced-dimensional embeddings may allow for faster similarity calculations, enabling the system to quickly locate and return relevant content slices. Moreover, dimension reduction may mitigate the risk of overfitting, where overly complex models might capture noise rather than meaningful patterns in the data. By focusing on the most significant dimensions, the data process flow 200 may maintain high accuracy in matching content slices to queries, while also ensuring that the document management process remains scalable and efficient even as the volume of data grows.

At step 252, the data process flow 200 may saving the output from step 244 (e.g., the dimensionally reduced embeddings) into the vector database 250. The vector database 250 may efficiently manage and store the high-dimensional embeddings, ensuring that they can be quickly retrieved and accurately matched against future search queries. The structure of the vector database 250 may be optimized for handling vast quantities of complex, high-dimensional data, which may maintain the performance and scalability of the document management system 102 as it processes increasing volumes of information.

The vector database 250 may utilize advanced indexing techniques, such as approximate nearest neighbor (ANN) search algorithms, to facilitate rapid and precise retrieval of embeddings based on their semantic similarity. The search algorithms may be used to perform efficient similarity searches, where the document management system 102 may need to quickly compare the query embeddings with the stored embeddings to identify the most relevant content slices. By organizing the embeddings in a way that preserves their semantic relationships, the vector database 250 may enable the system to deliver fast and contextually accurate search results, even when dealing with large datasets.

Moreover, the vector database 250 may incorporate robust encryption mechanisms to safeguard the stored embeddings and associated content slices. Given the sensitive nature of the data that might be processed, such as legal documents, medical records, or financial information, ensuring data security may be particularly important. The encryption mechanisms may ensure that the embeddings are protected from unauthorized access, both at rest and during transmission. This layer of security may comply with data protection regulations and for may maintain the trust of users who rely on the document management system 102 to handle confidential and sensitive information.

After storing the embeddings, the data segment process 230 may determine at step 236 whether there are more segments to process. If more segments are identified, the data process flow 200 may return to step 234 to extract and process the additional segments. If no further segments are present, the data fetcher process 220 at step 224 may check for additional files to process. If more files are available, the data process flow may return to step 222; otherwise, the user process 210 may conclude at step 212, marking the end of the data process flow 200.

This data process flow 200 may highlight the ability of the document management system 102 to handle complex data structures, efficiently segment and process documents, and securely store and retrieve information, as further detailed in the disclosure. Through innovative use of NLP models, high-dimensional embeddings, and/or vector databases, the document management system 102 may ensure that documents are managed in a manner that overcomes the limitations of traditional folder-based and tag-based management systems, offering a more advanced solution for document retrieval and management.

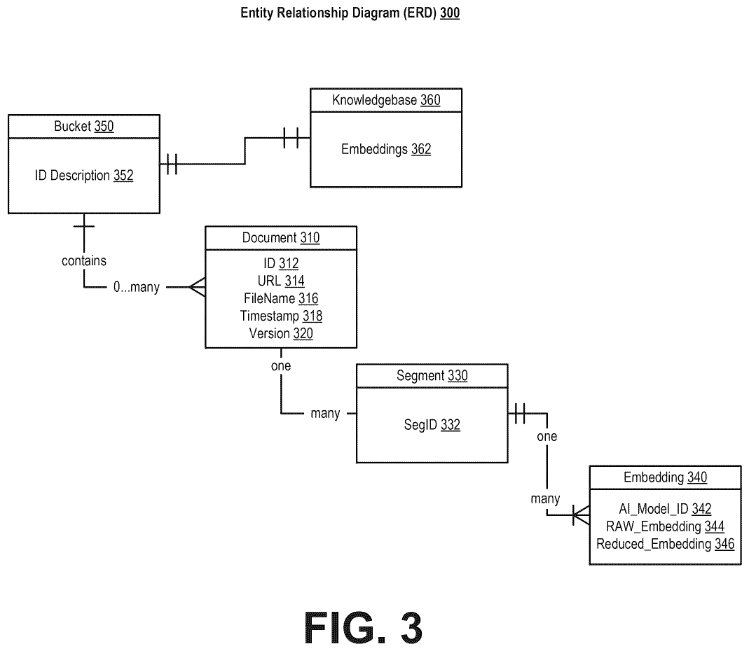

As illustrated in FIG. 3, the entity relationship diagram 300 illustrates an example of an overview of the relationships between various components within the document management system 102. Moreover, the entity relationship diagram 300 may illustrate how the document management system 102 organizes and processes electronic documents by breaking them down into segments, generating embeddings, and organizing them within buckets and knowledgebases. According to some aspects, the document management system 102 may facilitate efficient document management and retrieval while handling complex data structures with high accuracy and relevance to provide a robust solution for environments where precise document processing is essential.

The entity relationship diagram 300 may include several entities, e.g., a document 310, a segment 330, an embedding 340, a bucket 350, and/or a knowledgebase 360, each of which may play a role in managing and processing electronic documents.

The document 310 may represent one or more uploaded electronic files within the document management system 102. Each document 310 may include several attributes, such as an identifier attribute 312, a URL attribute, a filename attribute 316, a timestamp attribute 318, and a version 320. The identifier attribute may uniquely identify the document 310 within the document management system 102. The URL attribute 314 may store a link to the location of the actual file, allowing the document management system 102 to reference the document 310, e.g., without storing an entire file associated with the document 310 within the vector database 110.

Referencing the document 310 using the URL attribute 314 may reduce storage overhead and facilitate easier access to the document 310. The filename attribute 316 may provide a label for the document 310, while the timestamp attribute 318 may record a date or time associated with the creation or last modification of the document 310 (e.g., facilitating version control and tracking document history). The version 320 attribute may support version control by allowing the document management system 102 to manage different iterations of the same document and ensuring that users may access the most current or relevant version as needed.

The segment 330 may represent one or more logical divisions or “content slices” within the document 310, e.g., created during the data segmentation process. Each segment 330 may be associated with a segment identifier 332, which may uniquely identify the segment 330 within the document 310. The segmentation may allow the document management system 102 to break down complex documents into manageable and contextually coherent units, which may then be processed and retrieved. The one-to-many relationship between the document 310 and the segment 330 may indicate that a single document 310 may be divided into multiple segments 330, each capturing a specific portion of the content of the document 310.

The embedding 340 may represent high-dimensional vectors computed for each segment 330 and encapsulating a semantic essence of the text. The embeddings 340 may enable advanced search and retrieval functionalities within the document management system 102. Each embedding 340 may include an AI model identifier 342, indicating which AI model (e.g., NLP models such as BERT or GPT) was used to generate the embedding 340. The raw embedding 344 may comprise the initial high-dimensional vector generated by the AI model, while the reduced embedding 346 may comprise a dimensionally reduced version of the raw embedding (e.g., optimized for storage and retrieval efficiency within the vector database 110). The one-to-many relationship between the segment 330 and the embedding 340 may illustrate that each segment 330 may be processed by multiple AI models, resulting in different embeddings that capture various semantic perspectives.

The bucket 350 may group related documents together, serving as a container for managing and organizing documents within the document management system 102. The bucket 350 may include an identifier description 352 to describe the purpose or characteristics of the bucket. This organizational structure may utilize efficient categorization and retrieval of documents based on specific criteria or use cases. The bucket 350 may have a one-to-many relationship with the document 310, indicating that a single bucket 350 may contain multiple documents 310. For example, documents may be grouped based on common themes, projects, or regulatory requirements.

The knowledgebase 360 may represent a collection of embeddings 362, which may be stored and managed as part of the knowledge repository of the document management system 102. The one-to-one relationship between the bucket 350 and the knowledgebase 360 may illustrate that each bucket is associated with a dedicated knowledgebase 360, which may store the embeddings 340 generated from the documents 310 within that bucket. This relationship may allow the document management system 102 to build a specialized knowledge repository for each group of documents, enabling more accurate and context-aware retrieval of information when users perform searches or queries.

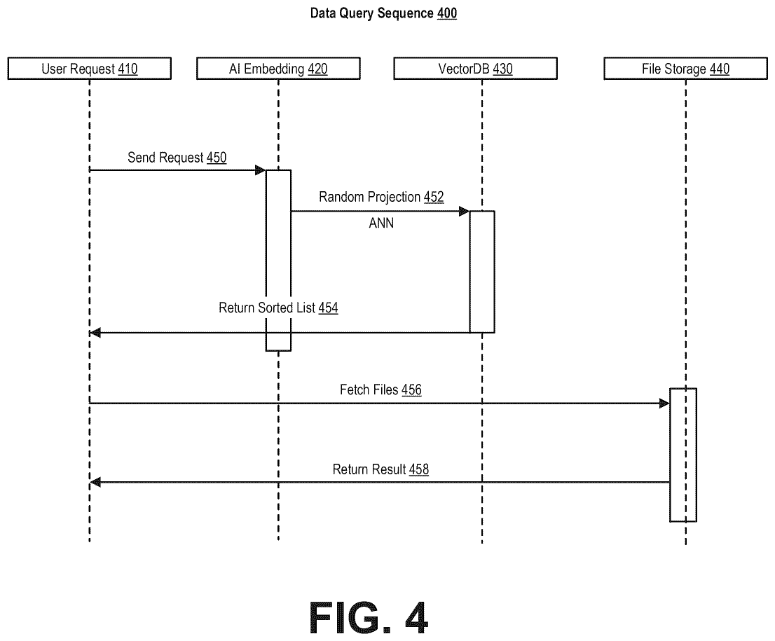

As illustrated in FIG. 4, a data query sequence 400 may include a series of interactions between various components of the document management system 102. According to some aspects, the data query sequence may utilize advanced AI techniques to ensure that the most relevant information is retrieved efficiently and accurately in response to a query. Moreover, the document management system 102 may handle various file formats, perform semantic slicing, and optimize search through embedding-based methods. Accordingly, the data query sequence 400 may represent a significant improvement over traditional document management systems, including automating document management and form completion, and may provide precise and rapid information retrieval for regulatory environments.

The data query sequence 400 may commence when a user request 410 is initiated. This user request 410 may originate from a user interacting with a user interface (UI) of the document management system 102, where the user may seek to retrieve specific information or documents stored within the document management system 102. The request may include a query for relevant content based on criteria, such as keywords, topics, or complex natural language queries encapsulating a more nuanced intent.

At step 450, the user request 410 may be transmitted to the AI embedding 420. The AI embedding 420 may transform the raw input from the user into a format that can be efficiently processed by the document management system 102. For example, the AI embedding 420 may generate a high-dimensional representation of the request. The high-dimensional representation may comprise a mathematical vector that encapsulates the semantic meaning of the query, allowing the system to perform sophisticated searches.

The AI embedding 420 may leverage a pre-trained natural language processing (NLP) model to generate this high-dimensional representation. The NLP models may include one or more algorithms such as BERT (Bidirectional Encoder Representations from Transformers), GPT (Generative Pre-trained Transformer), or similar architectures. The NLP models may be used to understand and encode the complexities of human language. The NLP model may process the textual input of the query by tokenizing the text, analyzing its syntactic structure, and extracting semantic relationships between words and phrases. Through this process, the NLP model may convert the user's input into an embedding, e.g., a dense vector in a multi-dimensional space where semantically similar inputs are located closer together.

The high-dimensional embedding may allow the document management system 102 to perform context-aware searches within the vector database 430. By converting the user's query into a rich, multi-dimensional format, the document management system 102 may match the query against stored document embeddings with a high degree of accuracy, e.g., retrieving content that is contextually relevant. The precision and relevance of the search results may be enhanced accordingly, making the document management system 102 more effective at handling complex and varied queries.

At step 452, the AI embedding 420 may execute a random projection process to transform the high-dimensional query generated from the user request into a format that is more manageable and suitable for efficient comparison within a vector database 430. The transformation process may optimize the search operations within the document management system, particularly when dealing with large-scale datasets that contain vast amounts of high-dimensional data.

The concept of random projection may include mapping the high-dimensional data into a lower-dimensional space in a way that approximately preserves the distances between points. Mapping the high-dimensional data may be based on the Johnson-Lindenstrauss lemma, which may embed a set of points in high-dimensional space into a lower-dimensional space such that the distances between the points are nearly preserved. The random projection may reduce the dimensionality of the query embedding while retaining the semantic relationships between the elements of the query. This reduced-dimensional representation may be used by the document management system 102 to perform rapid and efficient searches.

Moreover, the AI embedding 420 may apply one or more Approximate Nearest Neighbor (ANN) algorithms. The ANN algorithms may quickly find points in a dataset that are closest to a given query point, even in high-dimensional spaces. The ANN algorithms may strike a balance between computational expense and efficiency by finding an approximate nearest neighbor. By applying the ANN algorithms, the AI embedding 420 may transform the high-dimensional query into a lower-dimensional space where the nearest neighbors (i.e., the most relevant content slices or document segments in the vector database) may be identified more efficiently. This transformation may reduce the computational complexity of the search process, allowing the document management system 102 to handle large datasets without compromising on performance.

Moreover, the use of random projection combined with ANN algorithms may ensure that the search process remains scalable as the volume of data grows. As more documents and content slices are added to the vector database 430, the document management system 102 may continue to perform searches efficiently without a linear increase in computational load. This capability may be significant in enterprise environments where the document management system must handle a continuous influx of new data while still providing fast and accurate search results.

The vector database 430 may serve as the repository for the content slices and their associated high-dimensional embeddings. The embeddings may include numerical representations that encapsulate the semantic content of the document segments. At step 454, once the AI embedding 420 has performed the necessary transformations on the user query and generated a corresponding query embedding, the vector database 430 may process the query. The vector database may manage and store large volumes of high-dimensional data, including the content slices (e.g., segments of the original documents) and their associated embeddings. Storage of the embeddings may preserve their spatial relationships in a multi-dimensional space, ensuring that semantically similar content slices are positioned close to each other.

The query processing step may include the vector database 430 comparing the query embedding, which may represent the semantic essence of the user request, with the stored embeddings of the content slices. The comparison may be executed using similarity search algorithms, such as Approximate Nearest Neighbor (ANN) algorithms, which may efficiently locate the most relevant data points in high-dimensional spaces by identifying which of the stored content slices most closely match the semantic intent of the user query.

Once the vector database 430 has completed the comparison, it may generate a sorted list of relevant content slices. This list may be organized based on the degree of semantic similarity between the query embedding and the stored embeddings. The content slices that are determined to be the closest matches to the user query may be ranked higher in the list. The ranking may be determined by calculating the distance between the query embedding and each stored embedding in the vector space, e.g., the smaller the distance, the higher the relevance of that content slice.

This sorted list may represent a best approximation of the most relevant content slices in response to the request. The semantic similarity that may form the basis of the sorting may be used to retrieve content that is contextually appropriate and aligned with the intent of the user. Unlike traditional keyword-based search methods, which may return results that match specific terms but not the broader context, the use of the embeddings may allow the vector database 430 to account for the nuances of natural language, including synonyms, related concepts, and contextual meanings.

For example, if the user query relates to “intellectual property laws,” the vector database 430 may return content slices that not only mention “intellectual property” explicitly but also those that discuss related legal concepts, such as patents, trademarks, and copyright, even if those exact terms were not used in the query. This capability may be enabled by the high-dimensional embeddings, which may capture deeper semantic relationships between different pieces of text.

Additionally, the sorted list generated by the vector database 430 may include metadata associated with each content slice, such as the original location within the document, timestamps, and confidence scores indicating the relevance of each slice to the query. The metadata may be used by the document management system 102 to further refine the results presented to the user, offering a more tailored and precise response to their query.

At step 456 in the data query sequence 400, the user request 410 may initiate retrieval of one or more relevant files from the file storage 440. The file storage 440 (e.g., a distributed database or a cloud-based storage system) may serve as the repository for the original electronic files and their corresponding segmented content slices. The storage system may be robust, scalable, and secure and may handle large volumes of data, support multiple simultaneous access requests, and ensure data redundancy and security.

Retrieving files from the file storage 440 may begin once the user request 410 receives the sorted list of relevant content slices from the vector database 430. The sorted list may represent the content that is most semantically aligned with the query. To provide the user with the complete and original context, the document management system 102 may fetch the full files from which the relevant content slices were extracted.

The file storage 440 may store the electronic files in a manner that supports efficient retrieval. For example, the files may be indexed based on various attributes such as file type, creation date, associated metadata, and/or references to the segmented content slices. The storage system may also support version control, ensuring that users can access the most recent or historically relevant versions of the files as needed.

The user request 410 may initiate the retrieval process by referencing the identifiers or metadata associated with the relevant content slices. The identifiers may help the file storage 440 locate the exact files or portions of files that need to be retrieved. The storage system may utilize advanced indexing techniques to quickly locate the files, even within a distributed or cloud-based environment where data is spread across multiple servers or geographic locations.

Once the relevant files are located, the file storage 440 may fetch the files. For example, the segmented content slices may be assembled back into their original format or context, e.g., if the user request 410 requires the entire document rather than just the extracted slices. The storage system may include any associated metadata (e.g., annotations, timestamps, and/or version history) with the retrieved files.

At step 458, the file storage 440 returns the fetched files to the user request 410. This marks the completion of the data query sequence 400. The returned files are then made available to the user, either through a user interface or directly within the application that issued the query. Depending on the system's configuration, the user may receive the files in their entirety, or they may be presented with a summary or preview of the relevant content, with options to access the full documents as needed.

The architecture of the file storage 440 (e.g., distributed or cloud-based) may support high availability and quick access to data. In a distributed database, the files may be stored across multiple nodes, allowing for load balancing and fault tolerance. For example, in a cloud-based system, the storage may leverage the elasticity of cloud infrastructure to scale according to demand, providing rapid retrieval times even under heavy load conditions. Moreover, the file storage 440 may include security features such as encryption, access controls, and/or audit logs to ensure that the retrieval of files is both secure and compliant with relevant data protection regulations. For example, the security features may be used in environments where sensitive information, such as legal documents, medical records, or financial data, is stored and accessed.

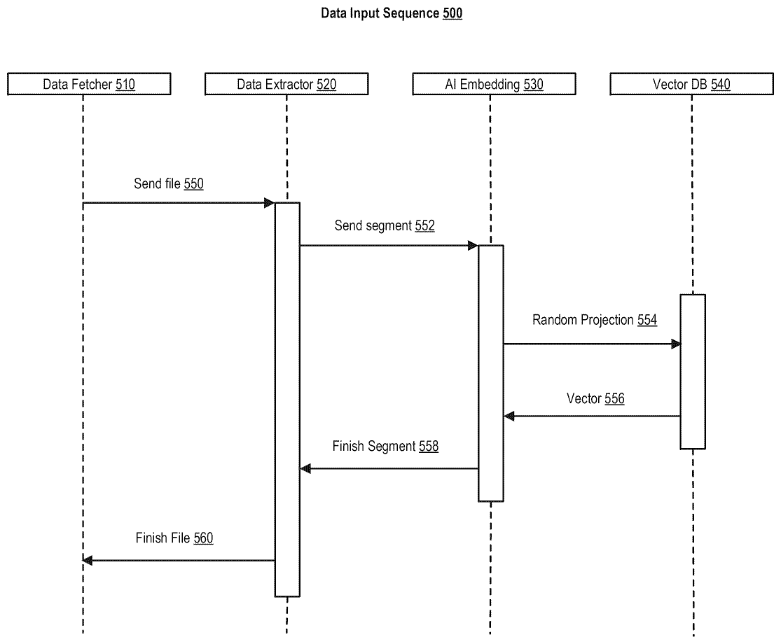

As illustrated in FIG. 5, a data input sequence 500 may set forth a process for handling data within the document management system 102. The data input sequence 500 may be used to manage, extract, and embed data in so that it is processed accurately and efficiently.

At step 550, the data input sequence 500 may include the data fetcher 510 transmitting a selected file to the data extractor 520 for detailed processing. The data fetcher 510 may efficiently locate and retrieve files from diverse storage environments, such as cloud-based storage systems or distributed data sources, so the necessary data is readily available for subsequent steps. This versatility in accessing various storage locations may enable the document management system 102 to handle a wide range of file types and formats, accommodating the dynamic and often decentralized nature of modern data management infrastructures. By seamlessly integrating with these storage environments, the data fetcher 510 may ensure that the data extractor 520 receives the correct file for further analysis and processing, laying the groundwork for the subsequent stages of the data input sequence 500.

At step 552, the data extractor 520 may segment the file and send the segments to the AI embedding 530. The data extractor 520 may break down the file into manageable content slices, allowing the AI embedding to process each segment individually. The segmentation may be based on semantic content by using one or more AI models to understand and maintain the contextual integrity of the text. According to some aspects, by preserving the integrity of the original file's semantic structure, the AI embedding 530 may generate accurate and meaningful high-dimensional embeddings for each content slice and enhance the overall effectiveness of the document management system 102.

At step 554, the AI embedding 530 may generate a high-dimensional random projection of the segment and send it to a vector database 540. The semantic content may be transformed into a format that can be efficiently stored and searched within the vector database. The AI embedding 530 may utilize one or more pre-trained natural language processing (NLP) models to generate embeddings that encapsulate the semantic essence of the text, ensuring that the content can be accurately retrieved based on its meaning.

At step 556, the vector database 540 may process the random projection and return a corresponding vector to the AI embedding 530. The vector database 540 may maintain and manage high-dimensional embeddings, which may enable rapid and accurate searches. The vector database 540 may handle large volumes of data, utilizing optimized similarity algorithms to compare and retrieve the most relevant vectors.

At step 558, the AI embedding 530 may use the vector to refine the segment and then send the finished segment back to the data extractor 520. The AI embedding may refine its understanding of the content so that the final output is both accurate and contextually relevant. According to some aspects, fuzzy operations may be handled based on semantic similarity.

At step 560, the data extractor 520 may compile the finished segments into a complete file and send the complete file back to the data fetcher 510. This final step ensures that the processed data is ready for use, whether for storage, further processing, or transmission to other systems. The system's support for automated data analysis and its ability to generate content summaries from processed documents further enhance the usability of the final output, making it a powerful tool for managing complex data structures.

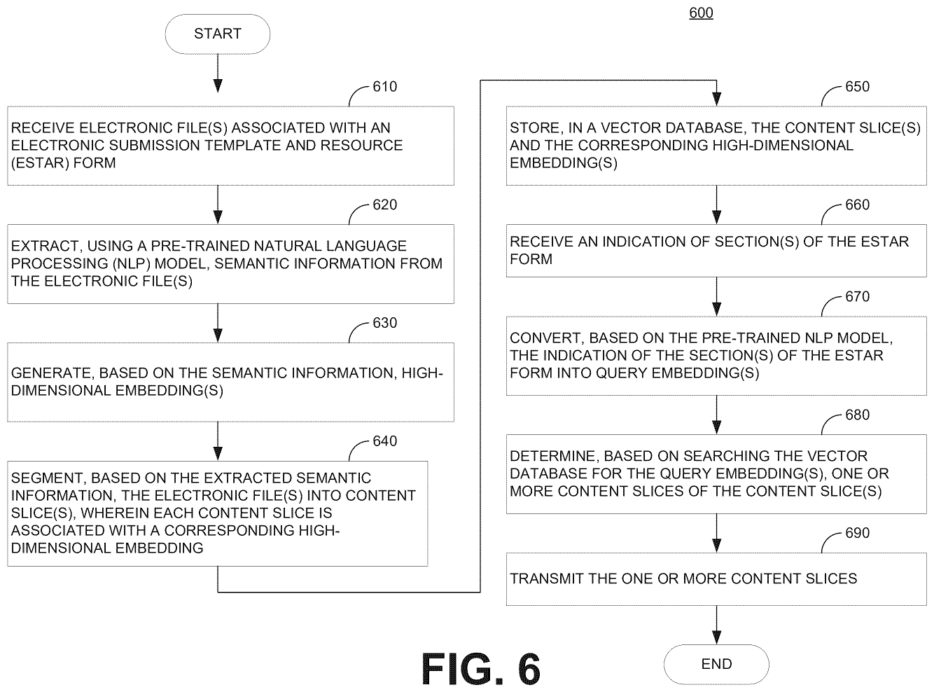

Referring now to FIG. 6, illustrated is a flowchart of a process 600, according to one example of the disclosed systems and processes. The process 600 may demonstrate a technique for artificial intelligence (AI) based document management and automated completion of electronic Submission Template and Resource (eSTAR) forms. The process 600 may provide a comprehensive approach to AI-driven document management, integrating advanced NLP techniques, high-dimensional embeddings, and optimized data storage and retrieval systems to automate and enhance the accuracy of eSTAR form completion. The process 600 may improve efficiency and ensure that the content inserted into the eSTAR forms is contextually accurate and relevant, thereby streamlining regulatory and administrative workflows.

At box 610, the process 600 may include receiving one or more electronic files associated with an eSTAR form. The electronic files may be received from one or more data environments, including document management systems, cloud storage platforms, email attachments, or directly from user uploads. The types of electronic files received may include text-based formats such as DOC and PDF, web-based formats such as HTML, and/or image-based formats including scanned images. The scanned images may undergo additional processing such as OCR to extract textual content. By accommodating diverse file formats, the process 600 may ensure that all pertinent data, regardless of its origin or format, can be seamlessly integrated into the eSTAR form.

The eSTAR form may be a standardized template for collecting, organizing, and/or processing a wide range of data, facilitating the submission of complex documents across various regulatory or administrative contexts. The eSTAR form may streamline document submission by ensuring that all necessary information is captured in a structured manner, reducing errors, and enhancing efficiency in document handling. Moreover, the eSTAR form may be used to manage submissions for regulatory compliance, legal documentation, or other formal processes that require comprehensive and accurate data input.

At box 620, the process 600 may include extracting (e.g., using a pre-trained NLP model) semantic information from the plurality of electronic files. Semantic information may comprise one or more of a meaning and/or a contextual relationship within the text, including key concepts, entities, and/or the overall intent of the content. The extraction may be performed using one or more AI techniques, such as pre-trained Natural Language Processing (NLP) models, which may be trained on datasets to recognize and interpret linguistic patterns. For example, an NLP model may be used to identify specific sections of a legal document, such as “Terms and Conditions” or “Confidentiality Clauses,” by understanding the context in which the terms appear.

Moreover, AI techniques may include named entity recognition (NER), which may evaluate an emotional tone of the document. For example, NER may be used to identify and/or categorize entities such as names, dates, and locations within the text. The AI techniques may be used to determine an underlying meaning of the text, ensuring that the most relevant information is extracted accurately. For example, in a medical document, different types of “cells” may be distinguished based on a surrounding context, such as “blood cells” versus “battery cells,” ensuring that the correct semantic meaning is captured. Additionally, machine learning algorithms such as BERT (Bidirectional Encoder Representations from Transformers) or GPT (Generative Pre-trained Transformer) may be used to analyze the syntax and semantics of sentences. This extraction process may ensure that the eSTAR form is populated with accurate and contextually relevant data, ultimately enhancing the quality and reliability of the submissions.

At box 630, the process 600 may include generating (e.g., based on the semantic information) a plurality of high-dimensional embeddings. The high-dimensional embeddings may include one or more numerical representations that represent a semantic essence of the extracted content. For example, high-dimensional embeddings may be vectors in a multi-dimensional space that encode the meanings and contextual relationships of text segments, transforming the meanings and contextual relationships into a format suitable for advanced computational analysis. According to some aspects, the embeddings may be generated using sophisticated Natural Language Processing (NLP) models, such as BERT (Bidirectional Encoder Representations from Transformers) or GPT (Generative Pre-trained Transformer), which may process the semantic information derived from the electronic files.

For example, if a document contains information about “machine learning algorithms,” an NLP model may analyze the text to understand its context and meaning, converting this understanding into a high-dimensional vector that captures various aspects of the term, including its relationships to other concepts like “neural networks” or “deep learning.” The embeddings may be created by tokenizing the text into smaller units, such as words or phrases, and then using the NLP model to generate vectors that represent these tokens in a high-dimensional space. This process may include capturing syntactic patterns, contextual meanings, and semantic nuances, ensuring that similar concepts are represented by vectors that are close to each other in this space. For example, an embedding for “artificial intelligence” may be positioned near embeddings for related terms like “AI” or “machine learning,” reflecting their semantic similarity. The high-dimensional embeddings may enable efficient and accurate retrieval and analysis of information by allowing for comparing and matching content based on its meaning rather than just its surface-level characteristics.

At box 640, the process 600 may include segmenting (e.g., based on the extracted semantic information) the electronic files into a plurality of content slices. Each content slice may be associated with a corresponding high-dimensional embedding. According to some aspects, the segmentation process may be based on the extracted semantic information such that each content slice represents a coherent and contextually relevant unit of information. The electronic files, which may include one or more formats such as DOC, PDF, or HTML, may be analyzed to identify logical divisions within the text, such as paragraphs, sections, or sentences that convey specific ideas or topics. For example, in a legal document, segments may correspond to clauses, articles, or definitions, while in a research paper, segments may align with sections such as introduction, methods, or results.

Each content slice may be associated with a corresponding high-dimensional embedding, which may numerically encode the semantic essence of the corresponding slice. These embeddings allow the content slices to be easily compared, retrieved, and analyzed based on their meaning rather than just their textual content. For example, a content slice discussing “data privacy regulations” may correspond to a high-dimensional embedding that reflects its relationship to related concepts like “GDPR” or “compliance,” making it possible to identify and retrieve the content slice when querying the system for topics related to legal compliance. The relationship between the content slices and their embeddings may enable the document management system to organize and manage large volumes of segmented data in a way that is both meaningful and efficient. This segmentation may facilitate precise information retrieval and may support the automated completion of the eSTAR form by ensuring that relevant, contextually accurate data is easily accessible.

At box 650, the process 600 may include storing (e.g., in a vector database) the plurality of content slices and the corresponding high-dimensional embeddings. The high-dimensional embeddings, which numerically capture the semantic relationships and meaning of the content slices, may be stored (e.g., as vectors) in the vector database in a way that preserves their spatial relationships within a multi-dimensional space.

According to some aspects, the vector database may be a specialized data storage system designed to efficiently manage and query high-dimensional embeddings. For example, unlike traditional relational databases that organize data into rows and columns, the vector database may structure data around high-dimensional embeddings (e.g., numerical representations of the semantic content of text, images, or other data types). The high-dimensional embeddings may be stored in a multi-dimensional space, where each dimension may correspond to a particular feature or aspect of the content, allowing the vector database to capture intricate relationships and contextual nuances. The vector database may be optimized for operations such as similarity search, which may include comparing high-dimensional embeddings to other high-dimensional embeddings to identify high-dimensional embeddings that are most similar to a query high-dimensional embedding. The vector database may utilize one or more indexing techniques, such as Approximate Nearest Neighbor (ANN) search algorithms, which may allow for efficient retrieval of relevant high-dimensional embeddings without the need to exhaustively compare every high-dimensional embedding in the database. The indexing techniques may significantly reduce computational complexity and make it possible to perform rapid searches even as the volume of stored high-dimensional embeddings grows.

According to some aspects, the vector database may support distributed storage and parallel processing, enabling the vector database to handle large-scale data sets by distributing the load across multiple nodes or servers. This architecture may provide high availability and fault tolerance in environments that require constant uptime and reliability. Moreover, the vector database may preserve the spatial relationships between high-dimensional embeddings, where the proximity of high-dimensional embeddings in the high-dimensional space may accurately reflect their semantic similarity. Preservation of the spatial relationships may enable contextually aware searches.

Each content slice may represent a segmented portion of the original electronic files and may be stored in the vector database with a direct association to its corresponding high-dimensional embedding. Pairing the content slice with the segmented portion of the original electronic files may ensure that the semantic essence of each content slice is preserved and is readily accessible. The vector database may maintain the content slices as individual records, allowing for precise and contextually relevant retrieval based on their semantic content.

The structure of the vector database may allow the database to perform rapid similarity searches, where the distance between high-dimensional embeddings in the high-dimensional space may be quickly calculated to determine which content slices are most relevant to a given query. For example, if a query seeks information related to “intellectual property,” the vector database may efficiently retrieve content slices whose high-dimensional embeddings are closely aligned with the semantic concepts of intellectual property law, patents, or trademarks.

At box 660, the process 600 may include receiving an indication of one or more sections of the eSTAR form. The indication (e.g., user input or system-generated) may specify one or more relevant sections of the eSTAR form to be populated. The eSTAR form may be a standardized digital document (e.g., used in various regulatory and administrative processes). According to some aspects, the eSTAR form may streamline the submission of required information by organizing data into predefined sections. Each section of the eSTAR form may correspond to a specific type of information, such as personal details, project summaries, or compliance data, and may be structured to ensure consistency and accuracy in the data collected. The indication of one or more sections of the eSTAR form may identify particular sections of the eSTAR form that need to be populated with relevant content.

The indication may be provided through various means, such as direct user input via an interface where the user selects or highlights sections of the form, or through automated system processes that determine the required sections based on the context of the submission or previously stored data. For example, input associated with the indication may be captured using graphical user interfaces (GUIs) equipped with clickable elements, dropdown menus, or checkboxes that allow users to specify their selections. In another example, the document management system may use pre-configured rules or machine learning algorithms to automatically determine which sections of the eSTAR form require completion based on the nature of the electronic files being processed.

At box 670, the process 600 may include converting (e.g., based on the pre-trained NLP model) the indication of the one or more sections of the eSTAR form into one or more query embeddings. The pre-trained NLP (Natural Language Processing) model may be a machine learning model designed to understand and process human language. The NLP model may be trained on vast amounts of text data, enabling it to recognize patterns, contextual meanings, and relationships between words and phrases. Based on the training, the model may generate query embeddings. The query embeddings may include numerical representations of textual data, e.g., that capture the semantic essence of the content.

Based on the received indication of one or more sections of the eSTAR form, the pre-trained NLP model may be used to convert the textual description or context of the one or more sections of the eSTAR form into query embeddings. Conversion of the indication of the one or more sections of the eSTAR form into the one or more query embeddings may include tokenizing the text by the NLP model tokenizes. Tokenizing the text may include breaking it down into individual words or phrases. The NLP model may analyze the syntactic structure and semantic content of the text to identify key concepts and relationships that are relevant to the specified sections of the eSTAR form.

For example, if a section of the eSTAR form relates to “Regulatory Compliance,” the NLP model may recognize terms and phrases associated with legal and regulatory standards and convert the recognized terms and phrases into a high-dimensional embedding. The high-dimensional embedding may be a vector that represents the semantic meaning of the “Regulatory Compliance” section in a numerical format, allowing it to be compared with other embeddings in the vector database.

The query embeddings generated by the NLP model may be used to search the vector database for relevant content slices that match the specified sections of the eSTAR form. The generated embeddings may be used to retrieve information that is contextually aligned with the requirements of the eSTAR form, facilitating accurate and efficient form completion.

At box 680, the process 600 may include determining (e.g., based on searching the vector database for the one or more query embeddings) a set of content slices of the plurality of content slices. The process employs optimized similarity algorithms to compare the query embeddings with the stored embeddings, ensuring that the most relevant content slices are selected.

When searching the vector database for the one or more query embeddings at box 680 of the process 600, the system utilizes optimized similarity algorithms to perform an efficient and accurate comparison between the query embeddings and the stored high-dimensional embeddings within the database. The vector database, designed to handle and manage high-dimensional data, indexes these embeddings in a way that preserves their semantic relationships, allowing for rapid retrieval. When a query embedding is generated based on the indication of the sections of the eSTAR form, the system initiates a search within the vector database by measuring the similarity between the query embedding and each stored embedding. This similarity is typically calculated using distance metrics, such as cosine similarity or Euclidean distance, which assess how closely related the embeddings are in the high-dimensional space.

The set of content slices is determined by identifying the stored embeddings that are most similar to the query embedding. The similarity algorithms rank these embeddings based on their proximity to the query embedding, with closer embeddings indicating a higher relevance to the query. The content slices associated with these top-ranked embeddings are then selected as the most relevant pieces of information to populate the specified sections of the eSTAR form.

Each content slice may represent a segment of the electronic files that has been previously processed and associated with an embedding that encapsulates its semantic content. By focusing on the embeddings that closely match the query, the retrieved content slices may be contextually aligned with the indicated sections of the eSTAR form. Moreover, completion of the eSTAR form may be automated with precise and relevant information.

At box 690, the process 600 may include transmitting the set of content slices. This transmission may involve inserting the content slices directly into the form, thereby automating the form completion process and significantly reducing the need for manual input. The set of content slices may be packaged in a structured format that may be seamlessly integrated into the eSTAR form. For example, the content slices may be converted into a compatible data format (e.g., XML, JSON) that aligns with the structure of the eSTAR form. Moreover, the set of content slices may be efficiently mapped to the corresponding sections of the eSTAR form.

A communication protocol, such as RESTful API or RPC (Remote Procedure Call), may be used to transmit the formatted content slices to a data entry interface of the eSTAR form. The received indications of the one or more sections of the eSTAR form may be used to accurately identify where each content slice should be inserted. The insertion process may be guided by metadata tags associated with the content slices, which may correspond to specific fields or sections within the eSTAR form. For example, if the indication specifies the “Project Details” section, the relevant content slice may be inserted into the pre-defined fields within that section of the form.

The content slices may be dynamically mapped to the appropriate form fields based on the structure and schema of the eSTAR form, ensuring that the content slices are placed in the correct context, preserving the semantic meaning and relevance of the content. Moreover, error-checking mechanisms may be implemented to verify that the data has been correctly inserted, reducing the likelihood of formatting issues or misplaced information. This automated process may speed up eSTAR form completion, enhance accuracy, minimize the need for manual input, and/or reduce potential for human error in complex document management tasks.

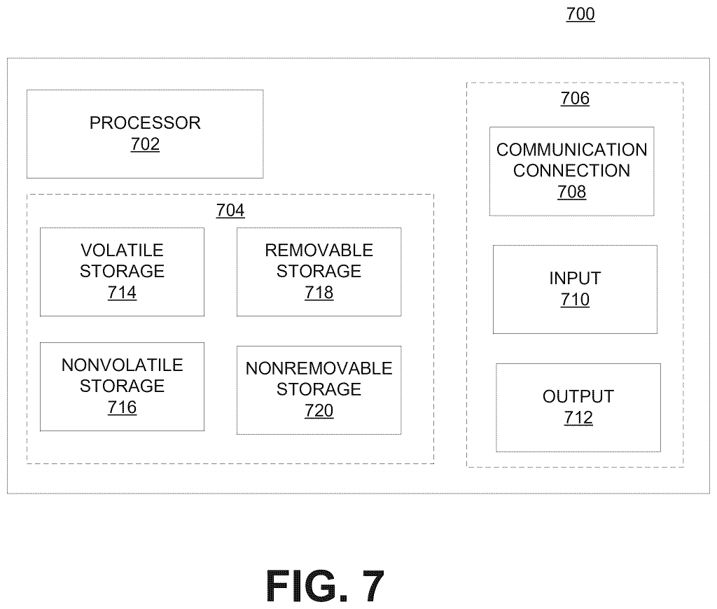

FIG. 7 is a block diagram of a computing device 700 that may be connected to or comprise a component of environment 100. Computing device 700 may comprise hardware or a combination of hardware and software. The functionality to facilitate document management and automated completion of electronic Submission Template and Resource (eSTAR) forms may reside in one or a combination of computing devices 700. Computing device 700 depicted in FIG. 7 may represent or perform functionality of an appropriate computing device 700, or a combination of computing devices 700, such as, for example, a component or various components of a document management system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 7 is exemplary and not intended to imply a limitation to a specific example or configuration. Thus, computing device 700 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 700 may comprise a processor 702 and a memory 704 coupled to processor 702. Memory 704 may contain executable instructions that, when executed by processor 702, cause processor 702 to effectuate operations associated with a document management system. As evident from the description herein, computing device 700 is not to be construed as software per se.

In addition to processor 702 and memory 704, computing device 700 may include an input/output system 706. Processor 702, memory 704, and input/output system 706 may be coupled together (coupling not shown in FIG. 7) to allow communications between them. Each portion of computing device 700 may comprise circuitry for performing functions associated with each respective portion. Thus, each portion may comprise hardware, or a combination of hardware and software. Accordingly, each portion of computing device 700 is not to be construed as software per se. Input/output system 706 may be capable of receiving or providing information from or to a communications device or other network entities configured for document management and automated completion of eSTAR forms. For example, input/output system 706 may include a wireless communication (e.g., 3G/4G/5G/Global Positioning System (GPS)) card. Input/output system 706 may be capable of receiving or sending video information, audio information, control information, image information, data, or any combination thereof.

Input/output system 706 may be capable of transferring information with computing device 700. In various configurations, input/output system 706 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 706 may comprise a Wi-Fi finder, a two-way GPS chipset or equivalent, or the like, or a combination thereof.

Input/output system 706 of computing device 700 also may contain a communication connection 708 that allows computing device 700 to communicate with other devices, network entities, or the like. Communication connection 708 may comprise communication media.

Communication media may embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 706 also may include an input device 710 such as keyboard, mouse, pen, voice input device, or touch input device. Input/output system 706 may also include an output device 712, such as a display, speakers, or a printer.

Processor 702 may be capable of performing functions associated with document management, such as functions for automated form completion, as described herein. For example, processor 702 may be capable of, in conjunction with any other portion of computing device 700, managing and processing electronic documents by extracting semantic information, generating high-dimensional embeddings, and automating form completion through advanced natural language processing (NLP) models and optimized similarity algorithms, as described herein.

Memory 704 of computing device 700 may comprise a storage medium having a concrete, tangible, physical structure. As is known, a signal does not have a concrete, tangible, physical structure. Memory 704, as well as any computer-readable storage medium described herein, is not to be construed as a signal. Memory 704, as well as any computer-readable storage medium described herein, is not to be construed as a transient signal. Memory 704, as well as any computer-readable storage medium described herein, is not to be construed as a propagating signal. Memory 704, as well as any computer-readable storage medium described herein, is to be construed as an article of manufacture.

Memory 704 may store any information utilized in conjunction with document management. Depending upon the exact configuration or type of processor, memory 704 may include a volatile storage 714 (such as some types of RAM), a nonvolatile storage 716 (such as ROM, flash memory), or a combination thereof. Memory 704 may include additional storage (e.g., a removable storage 718 or a non-removable storage 720) including, for example, tape, flash memory, smart cards, CD-ROM, DVD, or other optical storage, magnetic cassettes, magnetic tape, magnetic disk storage or other magnetic storage devices, Universal Serial Bus(USB)-compatible memory, or any other medium that can be used to store information and that can be accessed by computing device 700. Memory 704 may comprise executable instructions that, when executed by processor 702, cause processor 702 to effectuate operations associated with document management.

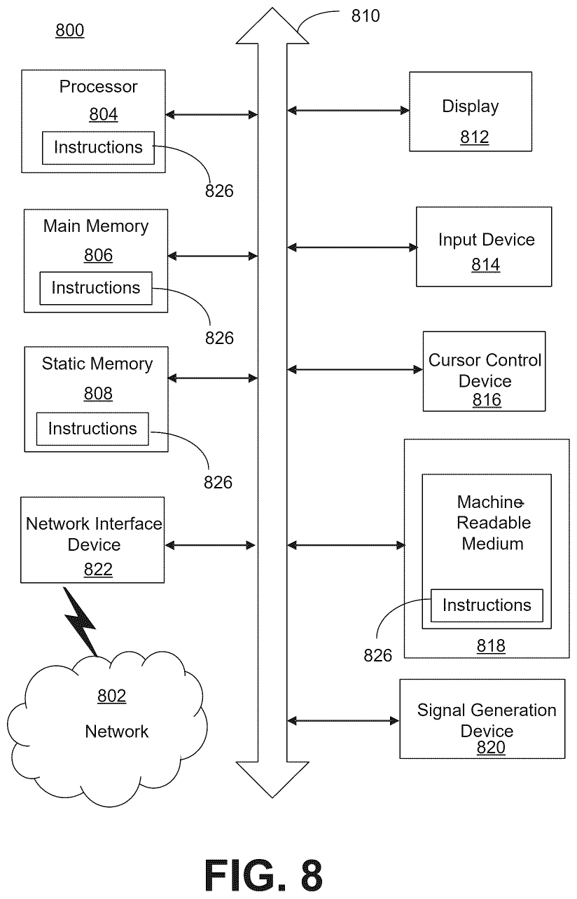

FIG. 8 depicts an exemplary diagrammatic representation of a machine in the form of a computer system 800 within which a set of instructions, when executed, may cause the machine to perform any one or more of the methods described above. One or more instances of the machine can operate, for example, as processor 702, computing device(s) 104, server 108, vector database 110, and other devices of FIGS. 1-7. In some examples, the machine may be connected (e.g., using a network 802) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 800 may include a processor (or controller) 804 (e.g., a central processing unit (CPU)), a graphics processing unit (GPU, or both), a main memory 806 and a static memory 808, which communicate with each other via a bus 810. The computer system 800 may further include a display unit 812 (e.g., a liquid crystal display (LCD), a flat panel, or a solid-state display). Computer system 800 may include an input device 814 (e.g., a keyboard), a cursor control device 816 (e.g., a mouse), a disk drive unit 818, a signal generation device 820 (e.g., a speaker or remote control) and a network interface device 822. In distributed environments, the examples described in the subject disclosure can be adapted to utilize multiple display units 812 controlled by two or more computer systems 800. In this configuration, presentations described by the subject disclosure may in part be shown in a first of display units 812, while the remaining portion is presented in a second of display units 812.

The disk drive unit 818 may include a tangible computer-readable storage medium on which is stored one or more sets of instructions (e.g., instructions 826) embodying any one or more of the methods or functions described herein, including those methods illustrated above. Instructions 826 may also reside, completely or at least partially, within main memory 806, static memory 808, or within processor 804 during execution thereof by the computer system 800. Main memory 806 and processor 804 also may constitute tangible computer-readable storage media.

While examples of a system for document management have been described in connection with various computing devices/processors, the underlying concepts may be applied to any computing device, processor, or system capable of facilitating document management. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for document management. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with document management as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing document management as described herein. When implemented on a general-purpose processor, the program code combines with the processor to provide a unique device that operates to invoke the functionality of a document management system.

While the disclosed systems have been described in connection with the various examples of the various figures, it is to be understood that other similar implementations may be used, or modifications and additions may be made to the described examples of a document management system without deviating therefrom. For example, one skilled in the art will recognize that a document management system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure-managing and processing electronic documents by extracting semantic information, generating high-dimensional embeddings, and automating form completion through advanced natural language processing (NLP) models and optimized similarity algorithms-as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

1. One or more computing devices, comprising one or more processors, configured to:
receive a plurality of electronic files associated with an electronic Submission Template and Resource (eSTAR) form;
extract, using a pre-trained natural language processing (NLP) model, semantic information from the plurality of electronic files;
generate, based on the semantic information, a plurality of high-dimensional embeddings;
segment, based on the extracted semantic information, the electronic files into a plurality of content slices using a sliding window method, wherein each content slice of the plurality of content slices is associated with a corresponding high-dimensional embedding of the plurality of high-dimensional embeddings;
generate a vector database comprising a plurality of vectors, the corresponding high-dimensional embeddings, and one or more metadata tags, wherein the plurality of vectors represent the plurality of electronic files;
receive an indication of one or more sections of the eSTAR form, wherein the indication comprises a selection of the one or more sections on a user interface displaying the eSTAR form;
convert, based on the pre-trained NLP model, the indication of the one or more sections of the eSTAR form into one or more query embeddings;
determine a set of content slices of the plurality of content slices based on an optimized similarity search of the vector database for the one or more query embeddings, wherein the optimized similarity search comprises using machine learning to determine a degree of semantic similarity between the one or more query embeddings and one or more high dimensional embeddings stored within the vector database;
convert the set of content slices into a data format compatible with the eSTAR form; and
insert each of the set of content slices into the user interface using an API based on a mapping to the one or more sections.

2. The one or more computing devices of claim 1, wherein the vector database is searched for the one or more query embeddings using an optimized similarity algorithm.

3. The one or more computing devices of claim 1, wherein the optimized similarity search comprises determining a similarity score for each of the one or more query embeddings, wherein the one or more content slices of the plurality of content slices are determined based on the similarity score.

4. The one or more computing devices of claim 1, wherein the one or more computing devices are further configured to insert the one or more content slices into the eSTAR form, wherein the one or more content slices are transmitted on the eSTAR form.

5. The one or more computing devices of claim 1, wherein the one or more computing devices are further configured to:
receive an approval of the one or more content slices; and
update the vector database based on the approval.

6. The one or more computing devices of claim 1, wherein the plurality of high-dimensional embeddings is associated with content of the electronic files.

7. The one or more computing devices of claim 1, wherein the one or more computing devices are further configured to periodically update the pre-trained NLP model.

8. The one or more computing devices of claim 1, wherein the one or more computing devices are further configured to assign, based on the extracted semantic information, one or more metadata tags to each of the plurality of content slices.

9. The one or more computing devices of claim 1, wherein the pre-trained NLP model is trained using domain-specific data related to a type of submissions associated with the eSTAR form.

10. The one or more computing devices of claim 1, wherein the one or more computing devices are further configured to determine a confidence score for each of the plurality of content slices, wherein the set of content slices is determined based on the confidence score.

11. The one or more computing devices of claim 1, wherein each content slice of the plurality of content slices comprises a reference to a location associated with an electronic file of the plurality of electronic files.

12. The one or more computing devices of claim 1, wherein the set of content slices are determined based on one or more previous queries.

13. The one or more computing devices of claim 1, wherein the one or more computing devices are further configured to revert to a previous version of one or more content slices of the plurality of content slices.

14. (canceled)

15. The one or more computing devices of claim 1, wherein the plurality of electronic files comprises scanned image files and the one or more computing devices are further configured to extract text from the scanned images files.

16. A method performed by one or more computing devices, the method comprising:
receiving a plurality of electronic files associated with an electronic Submission Template and Resource (eSTAR) form;
extracting, using a pre-trained natural language processing (NLP) model, semantic information from the plurality of electronic files;
generating, based on the semantic information, a plurality of high-dimensional embeddings;
segmenting, based on the extracted semantic information, the electronic files into a plurality of content slices using a sliding window method, wherein each content slice of the plurality of content slices is associated with a corresponding high-dimensional embedding of the plurality of high-dimensional embeddings;
generating a vector database comprising a plurality of vectors, the corresponding high-dimensional embeddings, and one or more metadata tags, wherein the plurality of vectors represent the plurality of electronic files;
receiving an indication of one or more sections of the eSTAR form, wherein the indication comprises a selection of the one or more sections on a user interface displaying the eSTAR form;
converting, based on the pre-trained NLP model, the indication of the one or more sections of the eSTAR form into one or more query embeddings;
determining a set of content slices of the plurality of content slices based on an optimized similarity search of the vector database for the one or more query embeddings, wherein the optimized similarity search comprises using machine learning to determine a degree of semantic similarity between the one or more query embeddings and one or more high dimensional embeddings stored within the vector database;
converting the set of content slices into a data format compatible with the eSTAR form; and
inserting each of the set of content slices into the user interface using an API based on a mapping to the one or more sections.

17. The method of claim 16, wherein the vector database is searched for the one or more query embeddings using an optimized similarity algorithm.

18. The method of claim 16, wherein the optimized similarity search comprises determining a similarity score for each of the one or more query embeddings, wherein the one or more content slices of the plurality of content slices are determined based on the similarity score.

19. The method of claim 16, further comprising inserting the one or more content slices into the eSTAR form, wherein the one or more content slices are transmitted on the eSTAR form.

20. A system comprising:
one or more processors; and
memory coupled with the one or more processors, the memory storing executable instructions that when executed by the one or more processors cause the one or more processors to effectuate operations comprising:
receiving a plurality of electronic files associated with an electronic Submission Template and Resource (eSTAR) form;
extracting, using a pre-trained natural language processing (NLP) model, semantic information from the plurality of electronic files;
generating, based on the semantic information, a plurality of high-dimensional embeddings;
segmenting, based on the extracted semantic information, the electronic files into a plurality of content slices using a sliding window method, wherein each content slice of the plurality of content slices is associated with a corresponding high-dimensional embedding of the plurality of high-dimensional embeddings;
generating a vector database comprising a plurality of vectors, the corresponding high-dimensional embeddings, and one or more metadata tags, wherein the plurality of vectors represent the plurality of electronic files;
receiving an indication of one or more sections of the eSTAR form, wherein the indication comprises a selection of the one or more sections on a user interface displaying the eSTAR form;
converting, based on the pre-trained NLP model, the indication of the one or more sections of the eSTAR form into one or more query embeddings;
determining a set of content slices of the plurality of content slices based on an optimized similarity search of the vector database for the one or more query embeddings, wherein the optimized similarity search comprises using machine learning to determine a degree of semantic similarity between the one or more query embeddings and one or more high dimensional embeddings stored within the vector database;
converting the set of content slices into a data format compatible with the eSTAR form; and
inserting each of the set of content slices into the user interface using an API based on a mapping to the one or more sections.

21. The system of claim 20, wherein the one or more processors are further configured to:
merge two or more content slices of the plurality of content slices based a semantic similarity between the two or more content slices.
